(19) United States
(12) Patent Application Publication
(10) Pub. No.: US 2014/0041587 A1
(43) Pub. Date: Feb. 13, 2014

(54) Masking Device for Vapor Deposition of Organic Material of Organic Electroluminescent Diode

(71) Applicants: Taipi Wu, Shenzhen City (CN); Yuanchun Wu, Shenzhen City (CN)

(72) Inventors: Taipi Wu, Shenzhen City (CN); Yuanchun Wu, Shenzhen City (CN)

(73) Assignee: Shenzhen China Star Optoelectronics Technology Co. Ltd., Shenzhen City, Guangdong Province (CN)

(21) Appl. No.: 13/699,637

(22) PCT Filed: Aug. 17, 2012
(86) PCT No.: PCT/CN12/80289

§ 371 Date: Nov. 22, 2012

(30) Foreign Application Priority Data
Aug. 10, 2012 (CN) 201210284911.2

(51) Int. Cl. H05B 33/10

(52) U.S. Cl. CPC H05B 33/10
USPC 118/720

(57) ABSTRACT

The present invention provides a masking device for vapor deposition of organic material of an organic electroluminescent diode, which includes a mask frame, cover plates arranged at opposite end edges of the mask frame to face toward a vapor deposition side, and a mask positioned on the cover plates. The mask frame is rectangular in shape and has a central portion forming a rectangular receiving opening, whereby size of the receiving opening is variable through adjustment made on positions of the cover plates. The mask forms a plurality of openings that is uniformly distributed thereon. The masking device includes a mask that shows a uniform distribution of mass so as to avoid inconsistent timing of attraction of various zones of the mask during magnetic attraction of the mask and thus positional shift of pixel caused thereby.

### BACKGROUND OF THE INVENTION

1. Field of the Invention

The present invention relates to an organic electroluminescent diode, and in particular to a masking device for vapor deposition of organic material of an organic electroluminescent diode.

2. The Related Arts

An organic light-emitting diode or organic light-emitting diode display (OLED) is also referred to as an organic electroluminescent diode, which is a novel displaying technology of which the development was dated back to the middle of the 20th century. The organic electroluminescent diode has various advantages over a liquid crystal display, such as being fully solid state, active emission of light, high brightness, high contrast, being ultra thin, low cost, low power consumption, fast response, wide view angle, wide range of operation temperature, and being capable of flexible displaying. The structure of an organic electroluminescent diode generally comprises a substrate, an anode, a cathode, and an organic function layer and the principle of light emission is that multiple layers of organic materials that are of extremely small thickness is formed between the anode and the cathode through vapor deposition, whereby positive and negative carriers, when injected into the organic semiconductor films, re-combine with each other to generate light. The organic function layer of the organic electroluminescent diode is generally made up of three function layers, which are respectively a hole transport layer (HTL), an emissive layer (EML), and an electron transport layer (ETL). Each of the function layers can be a single layer or more than one layer. For example, the hole transport layer sometimes is further divided into a hole injection layer and a hole transport layer and the electron transport layer may also be divided into an electron transport layer and an electron injection layer. However, they are of substantially the same function and are thus collectively referred to as the hole transport layer and the electron transport layer.

Currently, the manufacture of a full color organic electroluminescent diode is generally done with three methods, which are RGB juxtaposition and individual emission method, white light in combination with color filter method, and color conversion method, among which the RGB juxtaposition and individual emission method is most promising and has the most practical applications.

In the process of manufacturing an organic electroluminescent diode with the RGB juxtaposition and individual emission method, metal masks are needed to achieve vapor deposition of organic material on partial areas of a light emission pixel of a light emission layer on a glass substrate and thus realize color displaying. The opening of the metal mask has a size that is determined according to the size of a light emission layer of a glass substrate of the organic electroluminescent diode that is subjected to vapor deposition. Before the vapor deposition, a magnetic disk located under the glass substrate attracts the metal mask to have the metal mask laid completely flat on the glass substrate so as to prevent the occurrence of shade effect that affects the quality of vapor deposition. However, since the effective opening zone and an ineffective zone of the metal mask have different mass, the zones of different masses will be attracted inconsistently in time when the metal mask is attracted by magnetic force, so that the opening of the metal mask cannot be effectively laid flat on a designated site. Further, with the development of the organic electroluminescent diode, especially the active matrix organic light-emitting diode (AMOLED), the product size of the organic electroluminescent diode and the size of the glass substrate used are both being increased. This requires a continuous increase of the size of metal masks for vapor deposition. However, the metal mask is generally of a small thickness (often not exceeding 50 um) and the vapor deposition operation of the organic electroluminescent diode requires extremely high precision of alignment between the metal mask and the glass substrate (positional error between a unit component of the metal mask and a pixel unit of the glass substrate being between −3 um to +3 um). Thus, a production process for a size-enlarged organic electroluminescent diode often leads to defect products due to organic material being vapor-deposited on other areas caused by incorrect alignment between the metal mask and the glass substrate, so as to greatly affect the manufacture performance and manufacture expense.

### SUMMARY OF THE INVENTION

An object of the present invention is to provide a masking device for vapor deposition of organic material of an organic electroluminescent diode, wherein through formation of openings in an ineffective zone of a mask, a difference between the mass of the ineffective zone and mass of an effective zone of the mask is substantially eliminated thereby avoiding inconsistent timing of attraction of the effective zone and the ineffective zone of the mask during magnetic attraction applied by a magnetic disk due to difference in mass and thus eliminating positional shift of pixel caused thereby and also preventing organic material from attaching to a non-vapor-deposition zone of a substrate through the arrangement of cover plates.

To achieve the object, the present invention provides a masking device for vapor deposition of organic material of an organic electroluminescent diode, which comprises: a mask frame, cover plates arranged at opposite end edges of the mask frame to face toward a vapor deposition side, and a mask positioned on the cover plates. The mask frame is rectangular in shape and has a central portion forming a rectangular receiving opening, whereby size of the receiving opening is variable through adjustment made on positions of the cover plates. The mask forms a plurality of openings that is uniformly distributed thereon.

The cover plates are made of a non-magnetic material and the mask is made of a magnetically attractive material.

The cover plates are made of stainless steel.

The cover plates are mounted to the mask frame through welding.

The mask is made up of a single screen plate or a plurality of screen plates jointed to each other.

The receiving opening has a size corresponding to size of a light emission layer on a glass substrate of the organic electroluminescent diode subjected to vapor deposition.

The masking device for vapor deposition of organic material of an organic electroluminescent diode further comprises a magnetic disk positionable above a glass substrate of the organic electroluminescent diode subjected to vapor deposition. The magnetic disk is arranged to correspond to the mask frame. The magnetic disk has a size that is greater than or equal to size of the mask frame.

The openings have identical structure and size and are arranged to correspond to sub-pixel points of pixel units of a light emission layer on a glass substrate of the organic electroluminescent diode subjected to vapor deposition.

The openings are slit type the openings.

The openings are slot type openings.

The present invention also provides a masking device for vapor deposition of organic material of an organic electroluminescent diode, which comprises: a mask frame, cover plates arranged at opposite end edges of the mask frame to face toward a vapor deposition side, and a mask positioned on the cover plates, the mask frame being rectangular in shape and having a central portion forming a rectangular receiving opening, whereby size of the receiving opening is variable through adjustment made on positions of the cover plates, the mask forming a plurality of openings that is uniformly distributed thereon;

wherein the cover plates are made of a non-magnetic material and the mask is made of a magnetically attractive material;

wherein the cover plates are made of stainless steel;

wherein the cover plates are mounted to the mask frame through welding;

wherein the mask is made up of a single screen plate or a plurality of screen plates jointed to each other;

wherein the receiving opening has a size corresponding to size of a light emission layer on a glass substrate of the organic electroluminescent diode subjected to vapor deposition;

further comprising a magnetic disk positionable above a glass substrate of the organic electroluminescent diode subjected to vapor deposition, the magnetic disk being arranged to correspond to the mask frame, the magnetic disk having a size that is greater than or equal to size of the mask frame;

wherein the openings have identical structure and size and are arranged to correspond to sub-pixel points of pixel units of a light emission layer on a glass substrate of the organic electroluminescent diode subjected to vapor deposition; and

wherein the openings are slit type the openings.

The efficacy of the present invention is that the present invention provides a masking device for vapor deposition of organic material of an organic electroluminescent diode, which comprises a mask that shows a uniform distribution of mass so as to avoid inconsistent timing of attraction of various zones of the mask during magnetic attraction of the mask and thus positional shift of pixel caused thereby. The masking device prevents organic material from attaching to a non-vapor-deposition zone of a substrate, reduces the manufacture cost of an organic electroluminescent diode and improves the manufacture performance thereof, and also facilitates the development of vapor deposition techniques for a large-sized organic electroluminescent diode.

For better understanding of the features and technical contents of the present invention, reference will be made to the following detailed description of the present invention and the attached drawings. However, the drawings are provided for the purposes of reference and illustration and are not intended to impose undue limitations to the present invention.

### BRIEF DESCRIPTION OF THE DRAWINGS

The technical solution, as well as beneficial advantages, of the present invention will be apparent from the following detailed description of an embodiment of the present invention, with reference to the attached drawings. In the drawings:

FIG. 1 is a schematic view showing the structure of a masking device for vapor deposition of organic material of an organic electroluminescent diode according to an embodiment of the present invention;

FIG. 2 is a schematic view showing the structure of a cover plate of the masking device of FIG. 1;

FIG. 3 is a schematic view showing the structure of a mask of the masking device of FIG. 1;

FIG. 4 is a schematic view showing the structure of a masking device for vapor deposition of organic material of an organic electroluminescent diode according to another embodiment of the present invention; and

FIG. 5 is a schematic view showing the structure of a masking device for vapor deposition of organic material of an organic electroluminescent diode according to a further embodiment of the present invention.

### DETAILED DESCRIPTION OF THE PREFERRED EMBODIMENTS

To further expound the technical solution adopted in the present invention and the advantages thereof, a detailed description is given to a preferred embodiment of the present invention and the attached drawings.

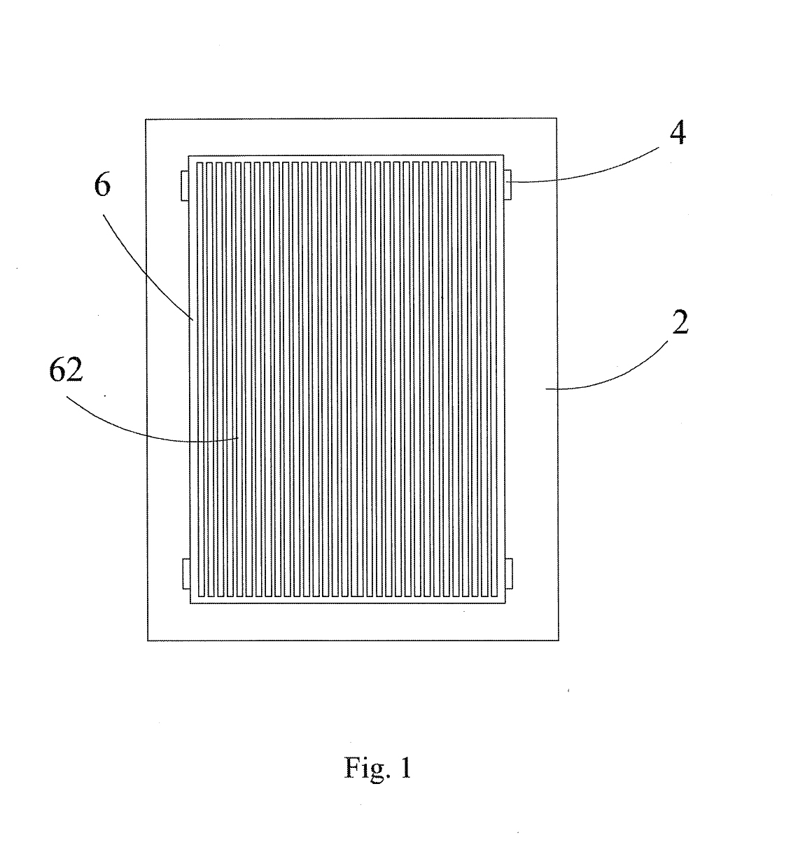

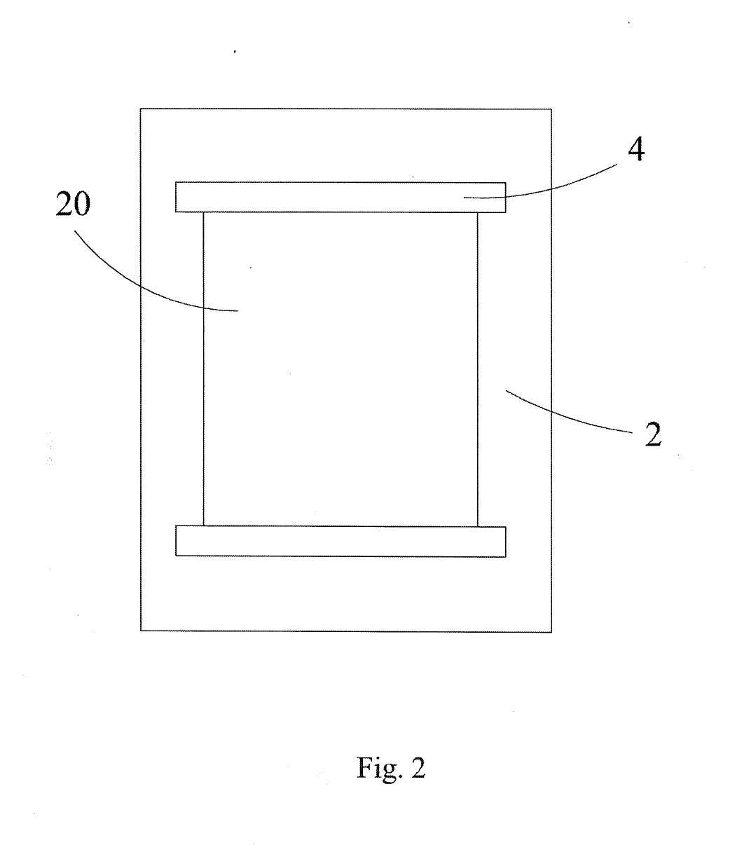

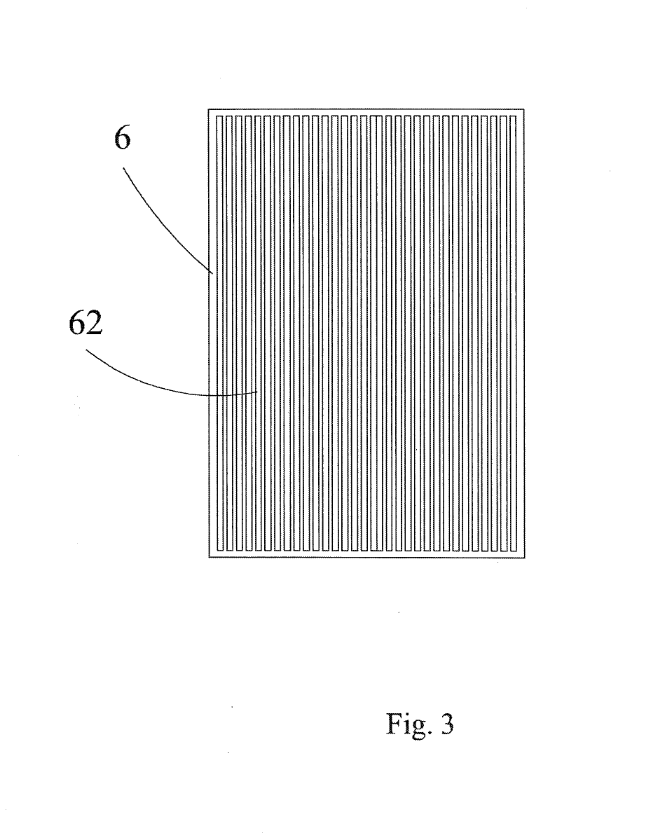

Referring to FIGS. 1-3, the present invention provides a masking device for vapor deposition of organic material of an organic electroluminescent diode, which comprises: a mask frame 2, cover plates 4 arranged at opposite end edges of the mask frame 2 to face toward a vapor deposition side, and a mask 6 positioned on the cover plates 4.

The mask frame 2 is rectangular in shape and has a central portion forming a rectangular receiving opening 20. The receiving opening 20 has a size that is arranged to correspond to the size of a light emission layer on a substrate of an organic electroluminescent diode to be subjected to vapor deposition.

The cover plates 4 are mounted to the mask frame 2 and are made of a non-magnetic material, preferably stainless steel (SUS) In carrying out vapor deposition, through adjustment made on the positions of the cover plates 4 on the mask frame 2, the size of the receiving opening 20 is varied in order to accord with the size of the light emission layer on the glass substrate of the organic electroluminescent diode to be subjected to vapor deposition thereby preventing organic material from attaching to a non-vapor-deposition area of the substrate.

The mask 6 is made of a magnetically attractive material (such as a ferrous material) and forms a plurality of openings 62 uniformly and completely distributed thereon. In the instant embodiment, the openings 62 are slit type openings. The openings 62 have the same structure and size and are arranged to correspond to sub-pixel points of pixel units of the light emission layer on the glass substrate of the organic electroluminescent diode to be subjected to vapor deposition.

In the instant embodiment, the mask 6 comprises a single screen plate.

The masking device for vapor deposition of organic material of an organic electroluminescent diode according to the present invention provides further comprises a magnetic disk (not shown) positionable above the glass substrate of the organic electroluminescent diode to be subjected to vapor deposition. The magnetic disk is arranged to correspond to the mask frame 2 in order to attract and retain the mask 6 on a vapor deposition surface of the glass substrate of the organic electroluminescent diode to be subjected to vapor deposition and to attract the mask frame 2 in order to tightly hold the mask 6 in position. Preferably, the magnetic disk has a size that is greater than or equal to the size of the mask frame 2. Since the mask 6 comprises the openings 62 that are completely and uniformly distributed thereof, the distribution of mass on the entire the mask 6 is made uniform, whereby when the magnetic disk attracts the mask 6, the attraction is effected simultaneously and consistently so as to avoid inconsistent attraction of the effective zone and the ineffective zone occurring in the known techniques due to mass difference and positional shift of pixels so caused.

During vapor deposition, the magnetic disk attracts and retains the mask 6 on the vapor deposition surface of the glass substrate of the organic electroluminescent diode that is subjected to vapor deposition and also attracts and holds the mask frame 2 and the cover plates 4 on the mask 6 so as to have the mask frame 2 and the cover plates 4 tightly positioned on the mask 6 to form an vapor deposition effective zone and vapor deposition ineffective zone on the mask 6 to carry out the vapor deposition process.

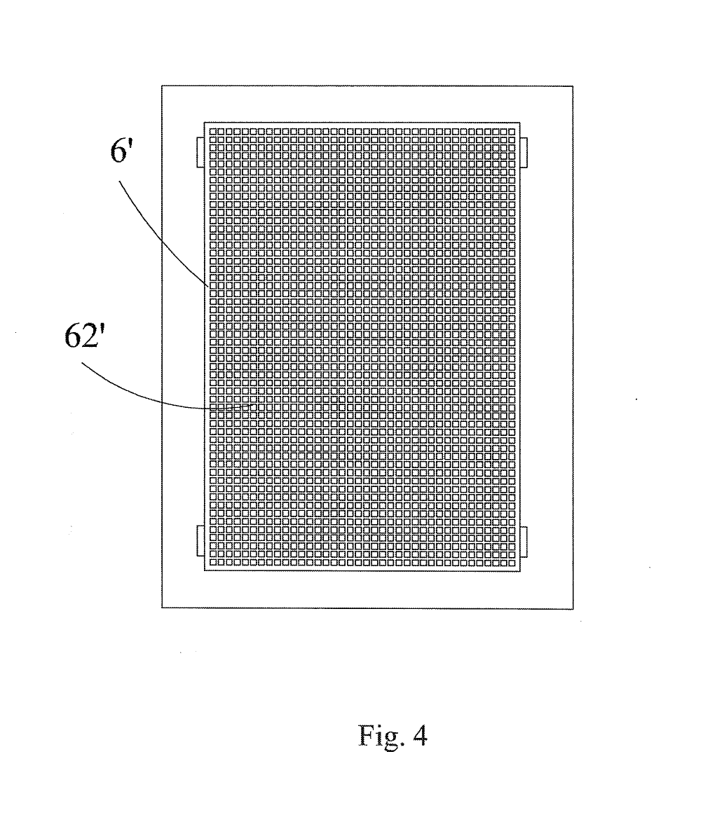

Referring to FIG. 4, which is a schematic view showing the structure of a masking device for vapor deposition of organic material of an organic electroluminescent diode according to another embodiment of the present invention, in the instant embodiment, a mask 6′ forms openings 62′ that are slot type openings. The openings 62′ have identical structure and size and are arranged t correspond to sub-pixel points of pixel units on a glass substrate of an organic electroluminescent diode to be subjected to vapor deposition.

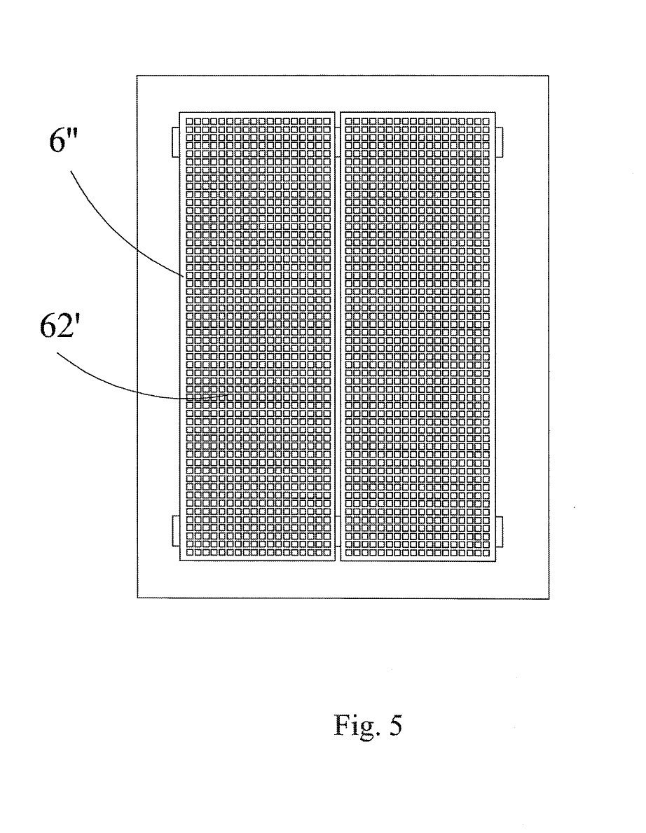

Referring to FIG. 5, which is a schematic view showing the structure of a masking device for vapor deposition of organic material of an organic electroluminescent diode according to a further embodiment of the present invention, in the instant embodiment, a mask 6″ is made up of two screen plates jointed to each other. The mask 6″ forms openings 62′ that are slot type openings. The openings 62′ have identical structure and size and are arranged to correspond to sub-pixel points of pixel units of light emission layer on a glass substrate of an organic electroluminescent diode to be subjected to vapor deposition. The two screen plates have identical structure and size and a gap formed therebetween has a width corresponding to width of the sub-pixel points of the pixel units of the light emission layer on the glass substrate of the organic electroluminescent diode subjected to vapor deposition so that a complete line of sub-pixel points is present in the gap and the complete line of sub-pixel points can be any one of three color sub-pixel points of red, green, and blue (R, G, B).

In summary, the present invention provides a masking device for vapor deposition of organic material of an organic electroluminescent diode, which comprises a mask that shows a uniform distribution of mass so as to avoid inconsistent timing of attraction of various zones of the mask during magnetic attraction of the mask and thus positional shift of pixel caused thereby. The masking device prevents organic material from attaching to a non-vapor-deposition zone of a substrate, reduces the manufacture cost of an organic electroluminescent diode and improves the manufacture performance thereof, and also facilitates the development of vapor deposition techniques for large-sized organic electroluminescent diodes.

Based on the description given above, those having ordinary skills of the art may easily contemplate various changes and modifications of the technical solution and technical ideas of the present invention and all these changes and modifications are considered within the protection scope of right for the present invention.

What is claimed is:

1. A masking device for vapor deposition of organic material of an organic electroluminescent diode, comprising: a mask frame, cover plates arranged at opposite end edges of the mask frame to face toward a vapor deposition side, and a mask positioned on the cover plates, the mask frame being rectangular in shape and having a central portion forming a rectangular receiving opening, whereby size of the receiving opening is variable through adjustment made on positions of the cover plates, the mask forming a plurality of openings that is uniformly distributed thereon.

2. The masking device for vapor deposition of organic material of an organic electroluminescent diode as claimed in claim 1, wherein the cover plates are made of a non-magnetic material and the mask is made of a magnetically attractive material.

3. The masking device for vapor deposition of organic material of an organic electroluminescent diode as claimed in claim 2, wherein the cover plates are made of stainless steel.

4. The masking device for vapor deposition of organic material of an organic electroluminescent diode as claimed in claim 1, wherein the cover plates are mounted to the mask frame through welding.

5. The masking device for vapor deposition of organic material of an organic electroluminescent diode as claimed in claim 1, wherein the mask is made up of a single screen plate or a plurality of screen plates jointed to each other.

6. The masking device for vapor deposition of organic material of an organic electroluminescent diode as claimed in claim 1, wherein the receiving opening has a size corresponding to size of a light emission layer on a glass substrate of the organic electroluminescent diode subjected to vapor deposition.

7. The masking device for vapor deposition of organic material of an organic electroluminescent diode as claimed in claim 2 further comprising a magnetic disk positionable above a glass substrate of the organic electroluminescent diode subjected to vapor deposition, the magnetic disk being arranged to correspond to the mask frame, the magnetic disk having a size that is greater than or equal to size of the mask frame.

8. The masking device for vapor deposition of organic material of an organic electroluminescent diode as claimed in claim 1, wherein the openings have identical structure and size and are arranged to correspond to sub-pixel points of pixel units of a light emission layer on a glass substrate of the organic electroluminescent diode subjected to vapor deposition.

9. The masking device for vapor deposition of organic material of an organic electroluminescent diode as claimed in claim 8, wherein the openings are slit type the openings.

10. The masking device for vapor deposition of organic material of an organic electroluminescent diode as claimed in claim 8, wherein the openings are slot type openings.

11. A masking device for vapor deposition of organic material of an organic electroluminescent diode, comprising: a mask frame, cover plates arranged at opposite end edges of the mask frame to face toward a vapor deposition side, and a mask positioned on the cover plates, the mask frame being rectangular in shape and having a central portion forming a rectangular receiving opening, whereby size of the receiving opening is variable through adjustment made on positions of the cover plates, the mask forming a plurality of openings that is uniformly distributed thereon;
wherein the cover plates are made of a non-magnetic material and the mask is made of a magnetically attractive material;
wherein the cover plates are made of stainless steel;
wherein the cover plates are mounted to the mask frame through welding;
wherein the mask is made up of a single screen plate or a plurality of screen plates jointed to each other;
wherein the receiving opening has a size corresponding to size of a light emission layer on a glass substrate of the organic electroluminescent diode subjected to vapor deposition;
further comprising a magnetic disk positionable above a glass substrate of the organic electroluminescent diode subjected to vapor deposition, the magnetic disk being arranged to correspond to the mask frame, the magnetic disk having a size that is greater than or equal to size of the mask frame;
wherein the openings have identical structure and size and are arranged to correspond to sub-pixel points of pixel units of a light emission layer on a glass substrate of the organic electroluminescent diode subjected to vapor deposition; and
wherein the openings are slit type the openings.
